(19) United States
(12) Patent Application Publication
(10) Pub. No.: US 2013/0232561 A1
(43) Pub. Date: Sep. 5, 2013

(54) COMMON DATA MODEL AND METHOD FOR SECURE ONLINE SIGNUP FOR HOTSPOT NETWORKS

(71) Applicant: Vivek Gupta, San Jose, CA (US)

(72) Inventor: Vivek Gupta, San Jose, CA (US)

(73) Assignee: INTEL CORPORATION, Santa Clara, CA (US)

(21) Appl. No.: 13/512,105

(22) PCT Filed: Nov. 4, 2011
(86) PCT No.: PCT/US11/59367

§ 371 Date: May 25, 2012

(51) Int. Cl. H04L 29/06

(52) U.S. Cl. CPC H04L 63/0823
USPC 726/5

(57) ABSTRACT

Embodiments of a subscription server and method for secure online signup with a common data model for Hotspot networks are generally described herein. In some embodiments, the subscription server is configured to generate and store a subscription management object (MO) that includes a plurality of nodes that define a subscription that has been provisioned for service by a wireless service provider. The subscription MO may include a home operator node that specifies home-operation information for an associated subscription and a credentials node that includes credentials for the associated subscription. The subscription MO may optionally include a policy node that identifies operator policy for the associated subscription and a subscription management node that identifies subscription management parameters for the associated subscription.

### RELATED APPLICATION

This application is related to U.S. patent applications Ser. No. 13/173,338 entitled “MOBILE DEVICE AND METHOD FOR AUTOMATIC CONNECTIVITY, DATA OFFLOADING AND ROAMING BETWEEN NETWORKS” (Attorney Docket No. 884.J38US1 (Client Ref. No. P37992) filed Jun.30, 2011, and Ser. No. 13/188,205 entitled “SECURE ONLINE SIGNUP AND PROVISIONING FOR WI-FI HOTSPOTS USING A DEVICE-MANAGEMENT PROTOCOL” (Attorney Docket No. 884.J39US1 (Client Ref. No. P37993) filed Jul. 21, 2011.

### TECHNICAL FIELD

Embodiments pertain to wireless communications. Some embodiments relate to wireless networks, such as wireless fidelity (Wi-Fi) networks. Some embodiments pertain to secure online signup and provisioning of credentials for service and connectivity may include subscription establishment. Some embodiments pertain to secure online signup for Hotspot 2.0 networks.

### BACKGROUND

The Wi-Fi infrastructure is evolving towards the Hotspot 2.0 program of the Wi-Fi alliance, which is intended to enable seamless connectivity, and traffic offload from third generation (3G) and fourth generation (4G) cellular networks to Hotspot 2.0 enabled Wi-Fi networks. One issue with seamless connectivity and traffic offload is that there is no standardized process for secure online signup, provisioning of credentials and subscription establishment for Wi-Fi enabled devices and networks. There is also no standardized data model for specifying credential and policy parameters for such subscriptions to enable seamless connectivity and traffic offload for such Wi-Fi enabled devices. There is also no standardized procedure for updating such subscriptions including updating the credential and policy parameters of these subscriptions.

Thus, there are general needs for subscription servers and methods for secure online signup with a common data model for Hotspot networks. What is also needed is a common data model that enables seamless connectivity as well as traffic offload for Hotspot 2.0 networks.

### BRIEF DESCRIPTION OF THE DRAWINGS

FIG. 1 illustrates an operational environment of network elements for secure online signup and provisioning of credentials in accordance with some embodiments;

FIG. 2A is a graphical representation of a subscription management object (MO) for Hotspot 2.0 provisioning in accordance with some embodiments;

FIGS. 2B through 2G show the status, occurrence, format and minimum access types for the elements of the subscription MO of FIG. 2A in accordance with some embodiments;

FIG. 3 is a functional block diagram of a mobile device in accordance with some embodiments;

FIG. 4 illustrates messages exchanged as part of a procedure for updating a subscription in accordance with some embodiments; and

FIG. 5 is a functional block diagram of a subscription server in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

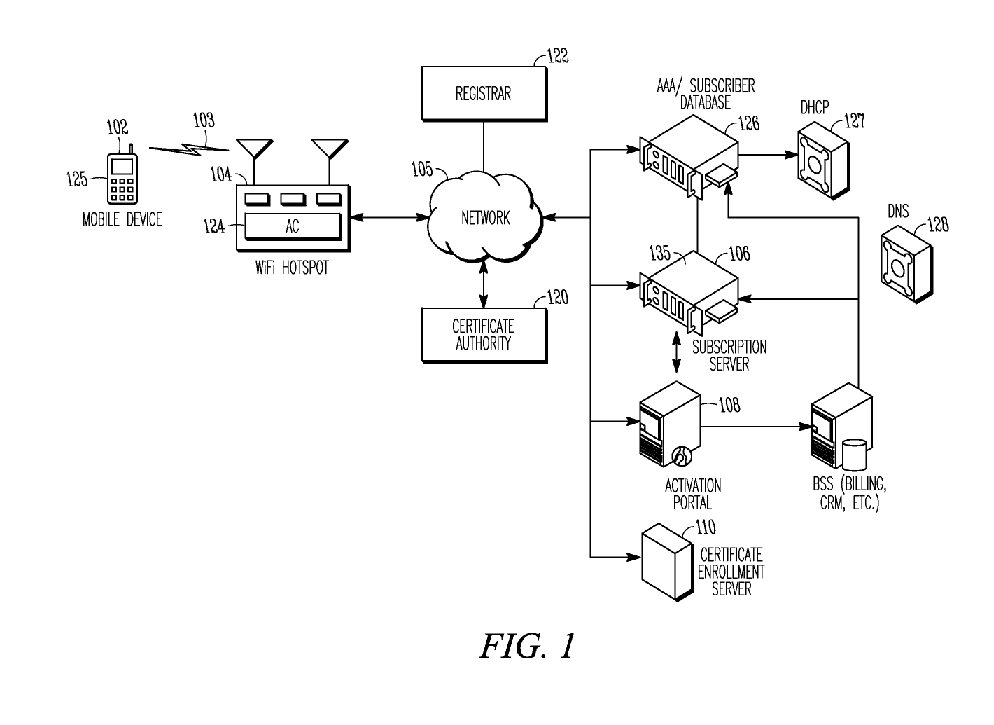

FIG. 1 illustrates an operational environment of network elements for secure online signup and provisioning of credentials in accordance with some embodiments. Mobile device 102 may be a Wi-Fi enabled device that is configured to associate with a Wi-Fi hotspot 104 and perform the various operations described herein for secure online signup and provisioning. The Wi-Fi hotspot 104 may provide Internet access over a wireless local area network (WLAN) with a router connected to a link to an Internet service provider (SP). The Wi-Fi hotspot 104 may be part of a Wi-Fi network and may be coupled to a network 105, such as the Internet or through a gateway to other various network elements may include a certificate authority 120, a subscription server 106, an activation portal 108, a certificate enrollment server 110, and a registrar 122 among other things. In some embodiments, the subscription server 106 may be a server configured to exchange messages in accordance with Simple Object Access Protocol (SOAP) extensible markup language (XML) techniques, although the scope of the embodiments is not limited in this respect. The Wi-Fi hotspot 104 may operate as a Wi-Fi access point (AP). The mobile device 102 may include a SOAP processing element 125 configured to implement SOAP-XML techniques and perform various operations described herein. Similarly, the subscription server 106 may include a SOAP processing element 135 configured to implement SOAP-XML techniques as described in more detail below.

In some embodiments, the Wi-Fi hotspot 104 may include an access controller (AC) 124 to serve as a management entity for the Wi-Fi hotspot 104. The access controller 124 may manage several access points of the Wi-Fi network and may operate as a gateway for a WLAN access network to provide access to other networks such as the Internet. The access controller 124 may perform various operations described here to allow mobile devices access to a Wi-Fi network.

In accordance with embodiments, the mobile device 102 may be configured for secure online signup and provisioning of credentials for Wi-Fi hotspots. In some embodiments, the mobile device 102 may be configured for secure online signup and provisioning for Wi-Fi hotspots using SOAP-XML techniques. In these embodiments, the mobile device 102 and the subscription server 106 may exchange request and response messages that are configured in accordance with a protocol such as SOAP.

The secure online signup and provisioning process described herein allows users to establish a subscription with a service provider and download credentials and operator policy onto a client device, such as the mobile device 102, in a secure manner using SOAP-XML techniques as a transport. This may allow cellular-type network service providers that may already be implementing SOAP-XML techniques in their backend core networks to use the same servers and installed components to extend that functionality for servicing Wi-Fi networks.

Some embodiments provide a standardized process for secure online signup and provisioning credentials. Credentials may include username/password credentials, certificate-based credentials and subscriber-information module (SIM) type credentials. The standardized process for secure online signup and provisioning credentials may be applicable to almost any IEEE 802.11-based network making the process applicable to both open and secure networks. A secure Wi-Fi network, for example, may implement security in accordance with a robust-security network (RSN) protocol. Such a network may be considered an RSN network (i.e., a security network that allows the creation of robust security network associations (RSNAs)). In some embodiments, secure online signup and provisioning of credentials may be performed automatically and without user interaction.

In accordance with embodiments, the mobile device 102 may be configured for secure online signup and provisioning for Wi-Fi Hotspot 2.0 networks. In these embodiments, the mobile device 102 may be configured to authenticate with a Wi-Fi network through the Wi-Fi Hotspot 104 using an Extensible Authentication Protocol (EAP) technique. As part of the authentication, a RADIUS ACCESS-ACCEPT message is received by the Wi-Fi hotspot 104 from an authentication, authorization, and accounting (AAA) server 126 to allow the mobile device 102 access to the Wi-Fi network and establish a Wi-Fi connection with the mobile device 102. The mobile device 102 may perform an initial SOAP exchange with the subscription server 106 over the established Wi-Fi connection to request provisioning of credentials for request subscription establishment. The initial SOAP exchange may include the mobile device authenticating the subscription server 106. The mobile device may also exchange information with the subscription server 106 to establish a subscription with a service provider for Wi-Fi network access, to provision credentials for the subscription, and to create a subscription MO for the provisioned credentials. The mobile device 102 may also perform a final SOAP exchange with the subscription server 106 over the Wi-Fi network to receive the subscription MO.

In these embodiments, in response to receipt of the RADIUS ACCESS-ACCEPT message, the Wi-Fi Hotspot 104 is configured to send an EAP-Success message to the mobile device 102 indicating a successful authentication. In some embodiments, the association with the Wi-Fi hotspot 104, the initial and final SOAP exchanges as well as authentication of the subscription server 106 may be performed without user input (i.e., automatically). In some embodiments, the exchange of information with the subscription server 106 for subscription establishment may also be performed without user input depending on the information needed. In some embodiments, the use may be prompted for user input.

In some embodiments, the initial SOAP exchange may include providing at least some device capability information of the mobile device 102 and indicating a reason for the request (e.g., provisioning of credentials or subscription establishment). When the reason for the request is provisioning of credentials, the subscription server 106 may indicate the type of credentials to be provisioned.

In some embodiments, the initial and final SOAP exchanges comprise messages configured in accordance with a SOAP technique using secure Hypertext Transfer Protocol (i.e., HTTPS) as an application layer protocol for transport. The messages may be configured in accordance with an XML message format. The HTTPS may include a combination of HTTP with a secure-socket layer transport-layer security (i.e., SSL/TLS) protocol to provide secure and encrypted communications.

In some embodiments, the RADIUS ACCESS-ACCEPT message may include access restrictions to be enforced by the Wi-Fi Hotspot 104. The access restrictions to limit access of the mobile device 102 to the Wi-Fi network for provisioning of credentials and subscription establishment and updating. The Wi-Fi Hotspot 104 may be configured to enforce the access restrictions by limiting the mobile device 102 to performance of the initial and final SOAP exchanges and the exchange of information with the service provider for either provisioning of credentials, subscription establishment or subscription updating.

After receiving the subscription MO, the mobile device may be configured to disassociate with the Wi-Fi Hotspot 104 after the final SOAP exchange, and re-associating with the Wi-Fi Hotspot 104 to re-establish a Wi-Fi connection. When re-associating, the mobile device 102 may be configured to use an EAP technique and may provide the provisioned credentials to the AAA server 126 over the re-established Wi-Fi connection. A RADIUS ACCESS-ACCEPT message may be received at the Wi-Fi Hotspot 104 from the AAA server 126 to grant the mobile device 102 access to the Wi-Fi network in accordance with the user's subscription. In some embodiments, the disassociating and re-associating may be performed without any user interaction. The Wi-Fi Hotspot 104 is configured to implement access restrictions indicated in the RADIUS ACCESS-ACCEPT message that are associated with the user's subscription.

In some embodiments, as part of the initial SOAP exchange with the subscription server 106, the subscription server 106 may be configured to determine the type of credentials to be provisioned and to indicate the type of credentials to be provisioned to the mobile device 102. The type of credentials to be provisioned may include one or certificate-based credentials, username/password credentials, or subscriber-information module SIM type credentials. The provisioning of credentials may include exchanging SOAP configured messages as described in more detail below. The type of credentials to be provisioned may be determined by the operator or service provider. Operator policy may be used determine the type of credentials to provision and use for authentication.

In accordance with embodiments, the mobile device 102 may be configured with registrar information, such as the uniform or universal resource locator (URL) of the registrar 122. The registrar 122 may contain service provider entries, which may include the service provider fully qualified domain name (FQDN), the service provider friendly name, and the service provider online signup root trust. The registrar 122 may provide cryptographic binding between the service-provider domain name and other data. The registrar 122 may be used by the mobile device 102 to establish a trust relationship between the mobile device 102 and an online signup server, such as subscription server 106. When the mobile device 102 initiates online signup, it may query the registrar 122 for metadata of the online signup server and may verify the authenticity of the online signup service provider. The mobile device 102 may also download the registry information in advance and may store it locally and use it when it initiates the secure online signup and provisioning process described herein. If the mobile device 102 is a dual-mode mobile device (e.g., having both cellular network capability and Wi-Fi network capability), the mobile device 102 may also be configured to query the registrar 122 in real-time using a cellular-network connection to retrieve online signup server information and to verify authenticity.

In accordance with embodiments, the mobile device 102 may be configured to associate with a Wi-Fi hotspot 104 of a Wi-Fi network and establish a TLS session with the subscription server 106 through the Wi-Fi hotspot 104 to receive a digital certificate of the subscription server 106. In accordance with embodiments, the mobile device 102 may exchange information over the established secure HTTP connection with the activation portal 108 to provision a subscription for Wi-Fi network access and create a subscription MO. The subscription MO may include a reference to the type of credentials (e.g., username/password, SIM-type or certificate-based) that have been provisioned for automatic connectivity to certain Wi-Fi networks may include Hotspot 2.0 networks.

In the case of username/password credentials, the subscription MO may include a username and password. In the case of SIM-type credentials, the subscription MO may include at least some basic information about the SIM-type credentials. In the case of certificate-based credentials, the subscription MO may include information for accessing certificate-based credentials.

Although many embodiments are described herein for secure online signup and provisioning for Wi-Fi Hotspot 2.0 networks, the scope of the invention is not limited in this respect. Other embodiments are applicable to secure online signup and provisioning for other types of networks may include other WLANs and cellular-type networks.

In accordance with some embodiments, the certificate authority 120 may be a Hotspot 2.0 Certificate Authority (CA) (i.e., the Root Trust) and may be configured to issue certificates may include Hotspot 2.0 certificates. The registrar 122 may be where a company or organization that is registered as a Hotspot 2.0 service provider. The registrar 122 may include an already registered FQDN and/or a chosen friendly name. The FQDN owner may be identified in a publicly available “WHOIS” database. The registrar 122 may invoke rules for registration that may allow the rejection of a requested friendly name, if not appropriate. The registrar 122 may maintain the database of registered service providers along with their friendly names and remove invalid entries.

In accordance with embodiments, the mobile device 102 may obtain one or more Hotspot 2.0 root certificate(s) from the certificate authority 120 and the root certificate may identify the server's FQDN and indicate that it is usable for HTTPS based authentication for online signup and provisioning of credentials. The Hotspot 2.0 service provider may provision the subscription server 106 with certificates from the certificate authority 120 and may provision appropriate policy settings on the online subscription server 106. These embodiments are discussed in more detail below.

The AAA server 126 may communicate with network elements such as a Dynamic Host Configuration Protocol (DHCP) server 127 for dynamic allocation of IP addresses and Domain Name Server (DNS) 128 for domain-name translation, as well as performing other networking operations.

In some embodiments, the Wi-Fi hotspot 104 may be a Wi-Fi Hotspot 2.0 operating in accordance with a Hotspot 2.0 evolution specification, such as the Hotspot 2.0 evolution specification of the Wi-Fi Alliance. The mobile device 102 may be a Hotspot 2.0 enabled device and the subscription information may include pre-provisioned subscription information for automatic connection to a Wi-Fi Hotspot 2.0. A Wi-Fi network may be a wireless network may include a Wi-Fi hotspot configured to operate in accordance with one of the IEEE 802.11 standards (and amendments thereto) for WLANs.

A Wi-Fi network may use collision-avoidance technique, such as carrier-sense multiple access with collision avoidance (CSMA/CA), in which upstream and downstream communications use the same frequency channels in accordance with a time-division multiplexed process. Some Wi-Fi networks may use orthogonal frequency division multiplexing (OFDM). Cellular networks, on the other hand, such as 4G Long Term Evolution (LTE) networks and WiMAX networks, implement an orthogonal-frequency division multiple access (OFDMA) technique. Third-generation (3G) cellular networks may use a code-division multiple access (CDMA) technique. In some embodiments, the mobile device 102 may be a dual-mode device having physical-layer circuitry configured for communicating with both Wi-Fi and cellular networks.

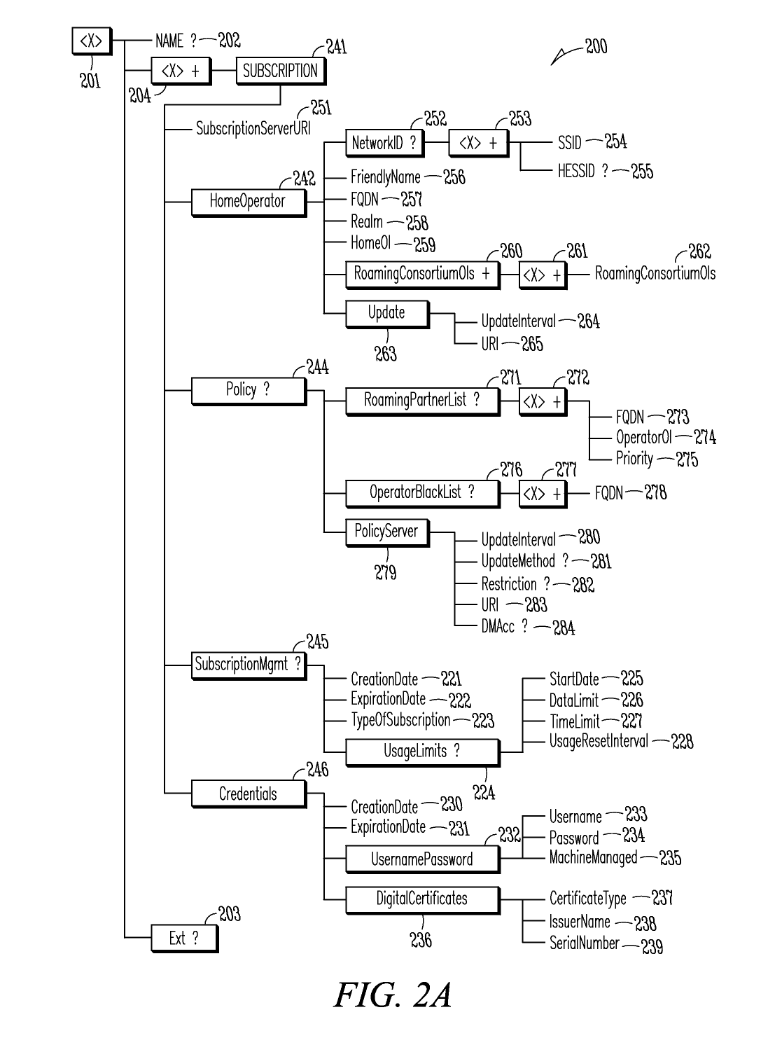

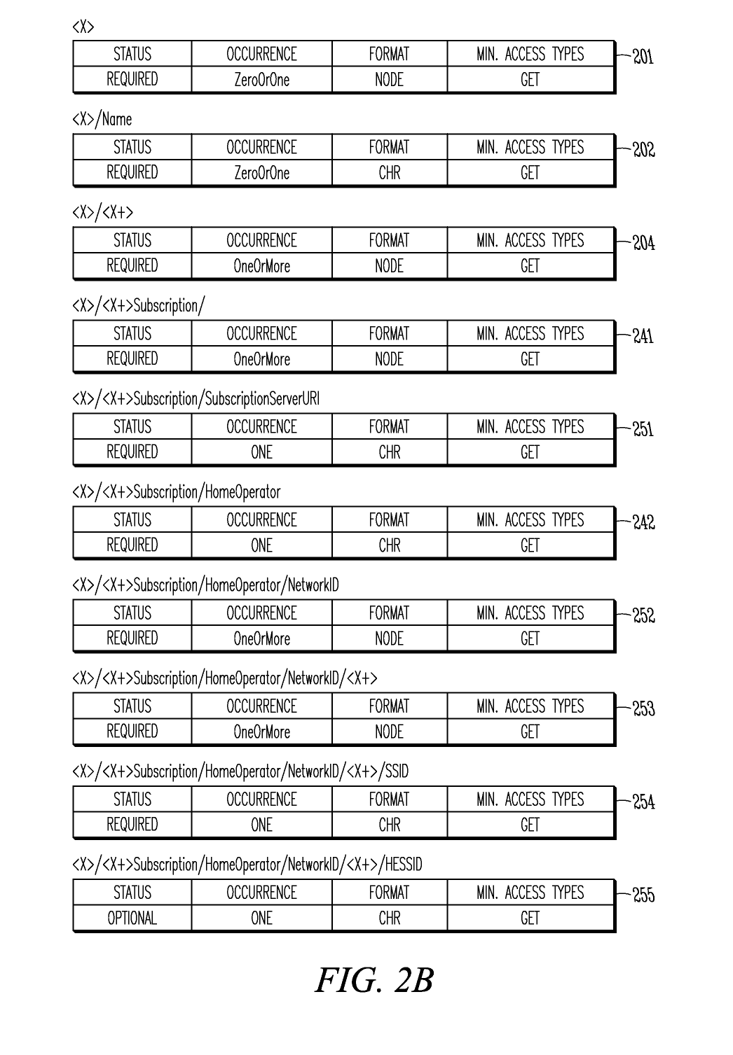

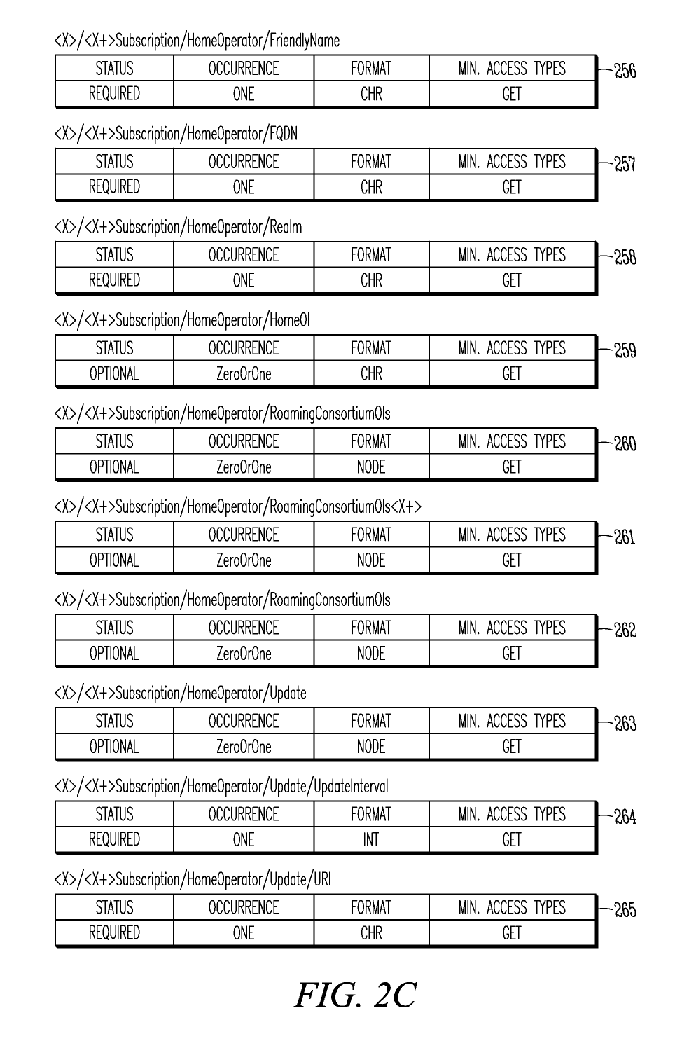

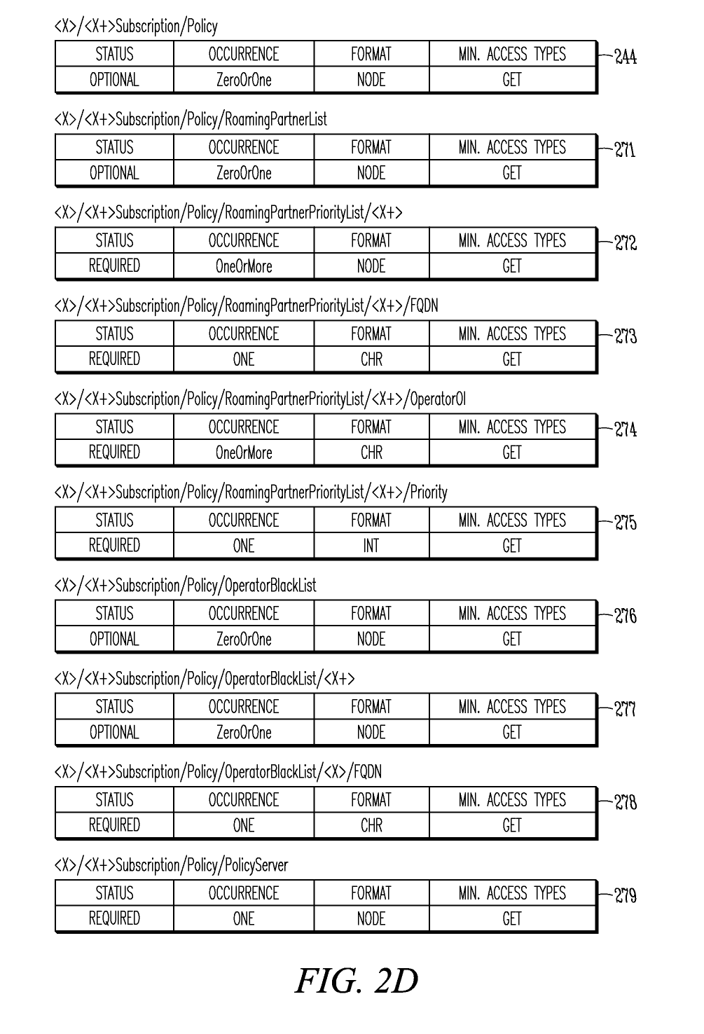

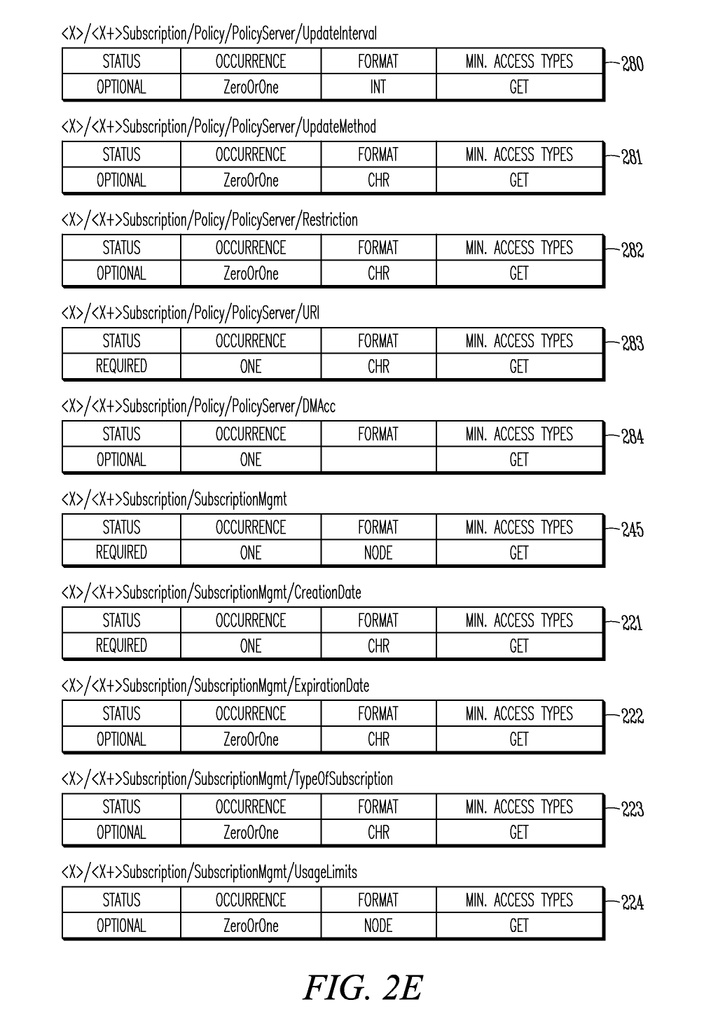

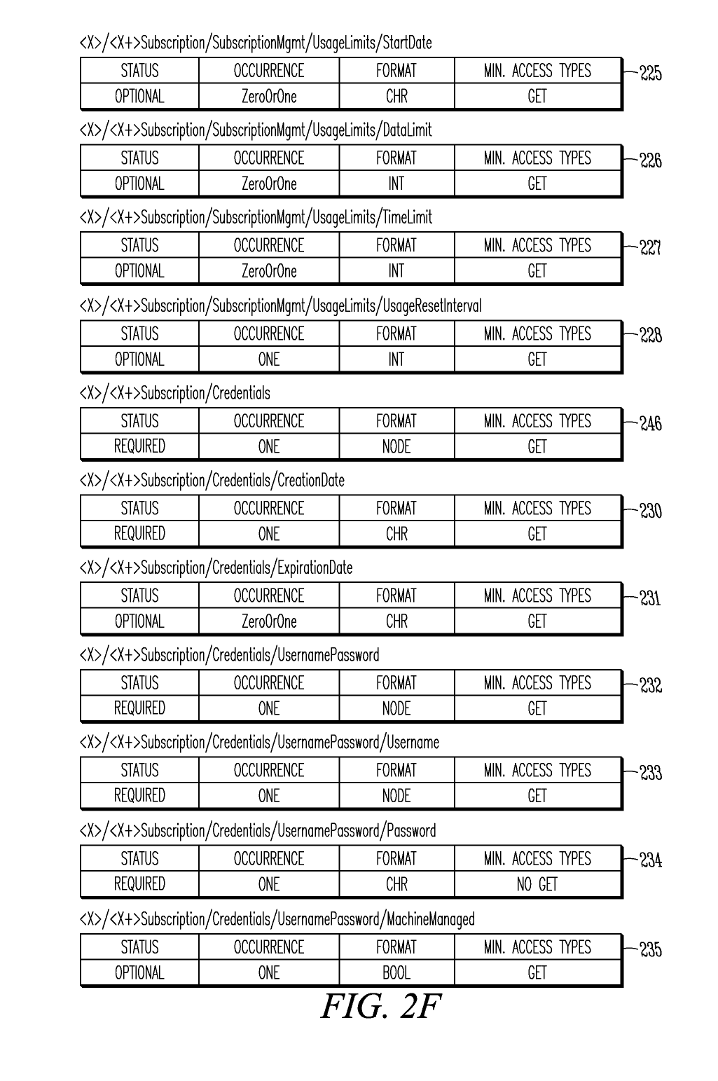

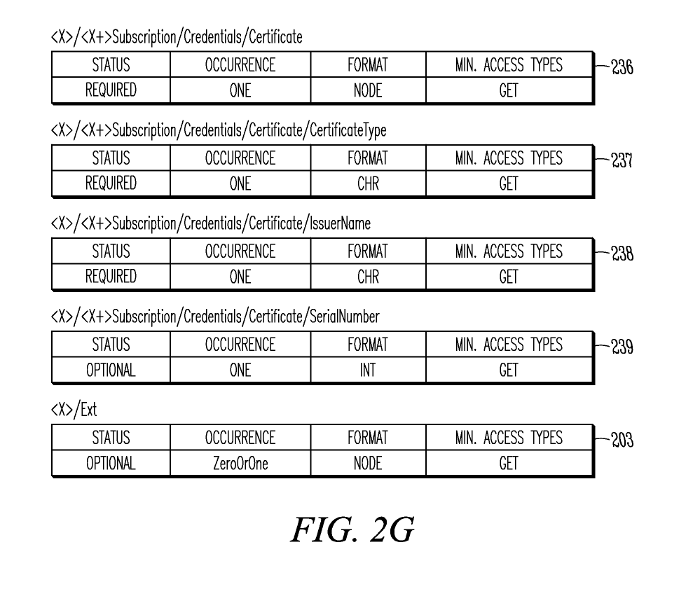

FIG. 2A is a graphical representation of a subscription MO 200 for Hotspot 2.0 provisioning in accordance with some embodiments. A subscription server, such as subscription 106 (FIG. 1), may be configured to generate and store the subscription MO 200. The subscription MO 200 comprises a plurality of nodes including subscription container node 201 that may serve as a container for the subscription. The subscription container node 201 may include an optional name leaf node 202, which may include a name for the associated subscription, and a subscription node 241.

The subscription node 241 defines the subscription that has been provisioned for service by a Wi-Fi service provider. The subscription node 241 may include for each subscription at least a home operator node 242 that specifies home-operation information for an associated subscription, and a credentials node 246 that may include credentials for the associated subscription. The subscription node 241 may optionally include a policy node 244 that identifies operator policy for the associated subscription, and a subscription management node 245 that identifies subscription management parameters for the associated subscription.

The subscription MO 200 may be a subscription-provisioning MO. In accordance with these embodiments, the subscription server 106 may be configured to provision a mobile device, such as mobile device 102 (FIG. 1), with the subscription MO 200. When provisioned with the subscription MO, the mobile device 102 may be configured to create an instance of the subscription MO 200 within the mobile device 102 for use in selecting and subscribing to a Wi-Fi Hotspot 2.0 104 of a Wi-Fi network in accordance with subscription information of the subscription MO 200. The subscription MO 200 may be in the form of a data structure and may be added to a device management tree of the mobile device 102.

In FIG. 2, the symbol “?” represents that there may be zero or one occurrence of the associated element. A zero occurrence means that the element is optional. The symbol “+” represents that there may be one or more occurrences of the associated element (i.e., the element is required). The subscription MO 200 may include subscription and policy specific parameters supporting subscriptions with service providers. The subscription MO 200 may be defined in accordance with an Open Mobile Alliance (OMA) Device Management Tree and descriptions specification, although this is not a requirement as it may also be defined in accordance with the SOAP-XML protocol. In accordance with these embodiments, the network to create and update the subscription MO 200 for provisioning a mobile device 102 may communicate over either the OMA-DM or the SOAP-XML protocol. Mobile device 102 may be Wi-Fi Hotspot 2.0 capable and may use HTTPS as the transport mechanism while connecting to a service provider's subscription servers. The mobile device 102 may use the provisioned subscription MO 200 to select and authenticate a network in accordance with the identifiers, policies, credentials and related metadata contained therein. In some embodiments, the identifier for the subscription MO 200 may be of the form “urn:wfa:mo:hotspot2dot0-subscription:1.0”.

In accordance with some embodiments, the subscription node 241 serves as a placeholder for subscription instance information for one or more subscriptions. The subscription node 241 may include a subscription server URI leaf node 251 that specifies a uniform resource identifier (URI) of the subscription server. In some embodiments, subscription server URI leaf node 251 may be formatted in accordance with RFC3986. The mobile device 102 may be configured to send subscription check commands to the subscription server 106 to update subscription specific information as described in more detail below.

In accordance with some embodiments, the home operator node 242 may include a network ID node 252 for network identity related information. The network ID node 252 may include one or more leaf nodes 254, 255 that specify a Wi-Fi network name of a Wi-Fi network to which the subscription is applicable. The Wi-Fi network name may be specified in accordance with a Wi-Fi standard. In some embodiments, network ID node 252 may be a placeholder for network ID related information, and container node 253 may be a container for the network identifiers of each service provider's home network. Leaf node 254, for example, may specify a Wi-Fi network name formatted in accordance with IEEE 802.11-2007. Leaf node 255, for example, may specify an IEEE 802.11u homogeneous extended service set (ESS) identifier of the Wi-Fi network formatted in accordance with IEEE 802.11u, although the scope of the embodiments is not limited in this respect.

In accordance with some embodiments, the home operator node 242 may include a leaf node 256 that specifies the friendly name of a home operator for the associated subscription, a leaf node 257 that specifies FQDN of the home operator in a predetermined format (e.g., formatted in accordance with RFC1035), and a realm leaf node 258 that specifies a realm of the home operator in a predetermined format (e.g., formatted in accordance with RFC4282). The home operator node 242 may also include a leaf node 259 comprising the organizational identifiers identifying the home service provider in a predetermined formation (e.g., in accordance with IEEE 802.11u), and an update node 263 that may include an update interval parameter 264 and a URI of the home service provider for receiving updates. In these embodiments, the update node 263 is an optional interior node that is a placeholder for updating home operator related information. The update interval parameter 264 may an interval value relative to the time when the account was created at which the mobile device 102 should connect to the subscription server 106 to update the subscription information. In some embodiments, a value of zero may be used to indicate that subscription management update is not used. The update interval parameter 264 may be in units that correspond to time.

The URI of the home operator service provider may be included in leaf node 265 to specify the URI of the home operator's server formatted according to RFC3986. The mobile device 102 may be configured to send home operator information check commands to the home operator server. The friendly name of home operator service provider may be a human language name chosen by the home operator service provider.

In accordance with some embodiments, the home operator node 242 optionally may include a roaming consortium organizational identifiers (OI) node 260 that may include organizational identifiers that identify any roaming consortiums of which the service provider is a member (e.g., in accordance with IEEE 802.11u). In these embodiments, node 260 is an optional interior node serving as a placeholder for a list of the organizational identifiers that identify roaming consortiums of which the service provider is a member. Container node 261 is an optional interior node that is a container for a list of organizational identifiers, and leaf node 262 may include the organizational identifier of a roaming consortium.

In accordance with some embodiments, the policy node 244 may include a roaming partner list node 271 that identifies the roaming partner priority list, an operator blacklist node 276 that may include an operator blacklist that lists operator friendly names that are not preferred by the home operator, and a policy server node 279 that identifies a policy server. The roaming partner list node 271 may include an interior container node 272 that identifies a preferred operator in the roaming partner priority list. The roaming partner list node 271 may include a leaf node 273 that specifies the FQDN of an operator in the priority list, which may be formatted in accordance with RFC1035. The roaming partner list node 271 may also include a leaf node 274 that is the Operator Organizational Identifier for the service provider in the roaming partner priority list. A leaf node 275 may specify the priority of an operator in the priority list. In some embodiments, the lower the value of the priority, the higher is the preference. The format of the priority may be an 8-bit unsigned integer, although the scope of the embodiments is not limited in this respect.

In some embodiments, the operator blacklist node 276 may include an interior container node 277 that contains the operator blacklist, which is a list of operator friendly names not preferred by the home operator. This interior container node 277 may serve as a container for operator friendly name in the operator blacklist. A leaf node 278 may specify the FQDN of a blacklisted operator. The FQDN may be formatted in accordance with RFC1035. In some embodiments, the subscription MO 200 may allow the user to manually select a network on the operator blacklist.

In accordance with some embodiments, the policy server node 279 may include a leaf node 283 that specifies the URI of the policy server in a predetermined format (e.g., formatted according to RFC3986), and a leaf node 280 that specifies an update interval for policy updates. In these embodiments, leaf node 280 may specify how often the mobile device 102 should check with the policy server 106 for policy updates. In some embodiments, the format of the Update Interval may be a 32-bit unsigned integer and its value may be specified in minutes. In some embodiments, OMA DM procedures may be used to update the policy.

In some embodiments, the policy server node 279 may include a leaf node 281 to specify the method the operator uses to update the policy. Some example values for the leaf node 281 may include ‘ClientInitiated’ or ‘ServerInitiatedHTTPPush’. If the value is Client Initiated, then the CheckInterval is present. In some embodiments, the policy server node 279 may include a leaf node 282 that specifies the hotspots at which the policy is permitted to be updated. Possible values include ‘HomeOperator’, ‘RoamingPartner’, or ‘Unrestricted. In some embodiments, the policy server node 279 may include a leaf node 284 that specifies the client account on a DM server. In some embodiments, a DMAcc management object may be specified in an OMA-DM standardized objects specification (e.g., OMADMSTDOBJ). In some embodiments, the mobile device 102 may be configured to send policy check commands to the URI of the policy server identified in leaf node 283.

In accordance with some embodiments, the credentials node 246 may include at least one of a username-password interior node 232 that serves as a container for username and password values of the credentials and may include a username leaf node 233 for a username, and a password leaf node 234 for a password. The credentials node 246 may also include a digital certificate interior node 236 that serves as a container for certificate-based credentials. The credentials node 246 may include a certificate-type leaf node 237 that specifics a certificate type, a certificate-issuer leaf node 238 that specifies a certificate issuer and a serial-number leaf node 239 that specifies a serial number of the certificate. In these embodiments, the credentials node 246 may include a creation date leaf node 221 that may include a parameter that parameter specifies the date and time (e.g., in UTC) that the subscription account was created. The date and time may be formatted as YYYY-MM-DDTHH:MM:SSZ where YYYY is the 4-digit year, MM is the 2-digit month ranging from 1 to 12, DD is the 2-digit day of the month ranging from 1 to 31, HH is the 24-hour time of day ranging from 0 to 23, MM is the minute of the hour ranging from 0 to 59, and SS is the second of the minute ranging from 0 to 59. An example creation date is “2011-01-30T08:31:14Z”.

In some embodiments, the credentials node 246 may also include an expiration date leaf node 222 that may include a parameter that specifies the date and time (e.g., in UTC) that the credentials will expire. This is an optional attribute and if it is not present, there may be no pre-determined expiration time and date. The formatting of the expiration date may the same as creation date.

In some embodiments, the user name leaf node 233 may specify the username formatted in accordance with an RFC-4282 compliant network access identifier (NAI). Note that that realm is not included in this parameter as the realm is provided in the realm leaf node 258 discussed above.

In some embodiments, the username-password interior node 232 may include a machine-managed leaf node 235, which may include an optional parameter to specify whether the password is machine managed. This is an optional attribute which when not present may indicate that the password is not machine managed. In some embodiments, the value of leaf node 235 may be a Boolean that may indicate that the password is machine managed and the mobile device 102 will be configured to prevent the user from changing the password's value.

In some embodiments, the certificate-type leaf node 237 specifies a certificate type and may be a value that is selected from IEEE 802.1ar or “x509v3” certificate types, although the scope of the embodiments is not limited in this respect. In some embodiments, the certificate-issuer leaf node 238 may specify the common name of the RDN, which may be the issuer name in the certificate.

In some embodiments, the credentials node 246 may include a creation date leaf node 230 that specifies a date and time when the credentials were created. The credentials node 246 may also include an expiration date leaf node 231 that specifies an expiration date and time for the credentials.

In some embodiments, the subscription management node 245 may include a creation date leaf node 221 that specifies a date and time when the subscription was created, an expiration date leaf node 222 that specifies an expiration date and time for the subscription, and an optional usage-limit node 224 that specifies accumulated usage statistical limits for this subscription. In some embodiments, the date and time of both the creation date leaf node 221 and the expiration leaf node 222 may be formatted as YYYY-MM-DDTHH:MM:SSZ. The expiration date leaf node 222 is optional and when it is not present, there may be no pre-determined expiration time and date, although the scope of the embodiments is not limited in this respect.

In some embodiments, the subscription management node 245 may also include a subscription-type leaf node 223, which may include an optional parameter that specifies the type of subscription associated with the account. Some example values for the subscription-type leaf node 223 may include “Platinum”, “Gold”, “Silver”, “Bronze” or other vendor specific values.

The usage limit node 224 may include a start date leaf node 225 leaf node that may include a parameter to specify a date and time at which usage statistics accumulation begins. The start date leaf node 225 may be in the same format as the creation date leaf node 221. The usage limit node 224 may also include an optional data limit leaf node 226 that specifies if present, the cumulative data limit (e.g., in megabytes) for a defined reset interval. If the value of this parameter is zero or it is not present, there may be an unlimited data usage for this account. When this limit is reached, the home service provider may, for example, be configured to either charge a higher tariff or disassociate the mobile device 102 from the network.

The usage limit node 224 may also include a time limit leaf node 227 that, when present, specifies a cumulative time limit in minutes for the defined reset interval. If the value of this parameter is zero or it is not present, there may be an unlimited time usage for this account. When this limit is reached, the home service provider may, for example, be configured to either charge a higher tariff or disassociate the mobile device 102 from the network. The usage limit node 224 may include a reset-interval leaf node 228 that may include a parameter to specify a value for usage. A value of zero may be used to indicate that resetting usage is not periodic (e.g., a one-time limit for a pay as you go (PAYG) service). A non-zero may specify a usage reset interval (e.g., in seconds).

In some embodiments, the subscription MO 200 may also include an optional vendor extension (Ext) node 203 to store vendor specific information about the subscription MO 200. The optional vendor extension node 203 is an interior node (as illustrated) where the vendor specific information about the subscription MO is placed. The vendor may be application vendor, device vendor, access point (AP) vendor etc. A vendor extension may be identified by a vendor specific name under the optional vendor extension node 203. In some embodiments, the tree structure under the optional vendor extension node 203 is not defined and may be configured to include one or more un-standardized sub-trees.

In some embodiments, at least some of the nodes of the subscription MO 200 are encoded in accordance with a multi-byte character-encoding format. In some embodiments, multi-byte character encoding format may be UTF-8, which refers to an 8-bit Universal Character Set (UCS) Transformation Format that uses multibyte character encoding for Unicode. Other multi-byte character-encoding format may also be suitable.

FIGS. 2B through 2G show the status, occurrence, format and minimum access types for the elements of the subscription MO of FIG. 2A in accordance with some embodiments. The status field may indicate whether the element is required or optional. The occurrence field may indicate zero, one, zero or one, or one or more, indicating the number of occurrences of the element. The format field may indicate whether the element is in character (CHR) format, Boolean, or a leaf node (NODE) or interior (INT) node.

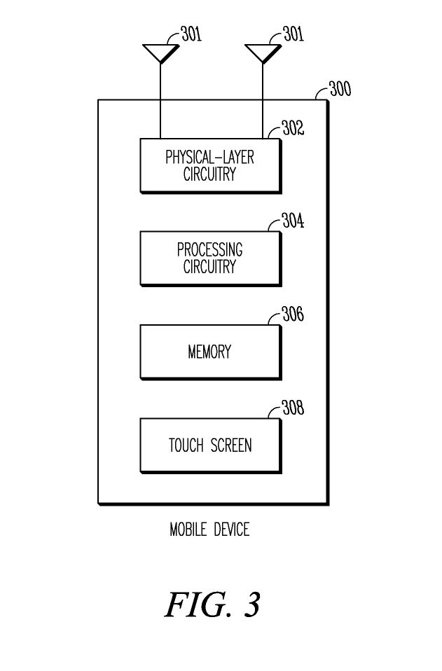

FIG. 3 illustrates a mobile device in accordance with some embodiments. Mobile device 300 may be suitable for use as mobile device 102 (FIG. 1) and may be configured to perform the various operations discussed herein for secure online signup and provisioning of credentials, as well as subscription establishment and updating.

Mobile device 300 may include physical-layer circuitry 302 configured for wireless communications with Wi-Fi hotspots, such as Wi-Fi hotspot 104 (FIG. 1) using one or more of antennas 301. Mobile device 300 may also include processing circuitry 304, which may be configured for performing the operations described herein. Mobile device 300 may also include data storage elements, such as a memory 306, for storing, among other things, a subscription MO, such as subscription MO 200 (FIG. 2A), as well as the other elements of a management object tree. The processing circuitry 304 may, for example, include a SOAP processing element for performing the various SOAP techniques described herein. Mobile device 300 may also include other functional elements, such as media-access control (MAC) layer circuitry for media access control for performing other operations, and a touch screen 308.

In some embodiments, the mobile device 300 may be configured to associate with a Wi-Fi network through a Wi-Fi Hotspot using an EAP technique. The mobile device 300 may also be configured to perform an initial SOAP exchange with the subscription server 106 (FIG. 1) over the established Wi-Fi connection to request provisioning of credentials for subscription establishment. The initial SOAP exchange may include the mobile device 300 authenticating the subscription server 106. The mobile device 300 may also be configured to exchange information with the subscription server 106 to establish a subscription with a service provider for Wi-Fi network access and to create an instance of the subscription MO 200 for the provisioned credentials. The mobile device 300 may also be configured to perform a final SOAP exchange with the subscription server over the Wi-Fi network to receive the subscription MO 200.

In the case of a single-mode mobile device, the physical layer circuitry 302 may be configured for communicating with Wi-Fi networks. In dual-mode embodiments, the physical layer circuitry 302 may be configured for communicating with both cellular networks and Wi-Fi networks. In dual-mode embodiments, the mobile device 300 may include both a Wi-Fi transceiver and one or more cellular network transceivers. In dual-mode embodiments, the mobile device 300 may also be configured to offload traffic from the cellular network to the available Wi-Fi networks, although the scope of the embodiments is not limited in this respect.

The mobile device 300 may be a portable wireless communication device, such as a personal digital assistant (PDA), a laptop or portable computer with wireless communication capability, a web tablet, a wireless telephone, a smart-phone, a wireless headset, a pager, an instant messaging device, a digital camera, an access point, a television, a medical or health device, an entertainment device, or other device that may receive and/or transmit information wirelessly.

Antennas 301 may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas 301 may be effectively separated to take advantage of spatial diversity and the different channel characteristics that may result between each of antennas 301 and the antennas of another communication device or station.

Although the mobile device 300 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), radio-frequency integrated circuits (RFICs) and combinations of various hardware and logic circuitry for performing at least the functions described herein. In some embodiments, the functional elements of mobile device 300 may refer to one or more processes operating on one or more processing elements.

In some embodiments, the mobile device 300 may include one or more of a keyboard, a display, a non-volatile memory port, multiple antennas, a graphics processor, an application processor, speakers, and other mobile device elements. The display may be a liquid-crystal display (LCD) screen may include a touch screen, such as touch screen 308.

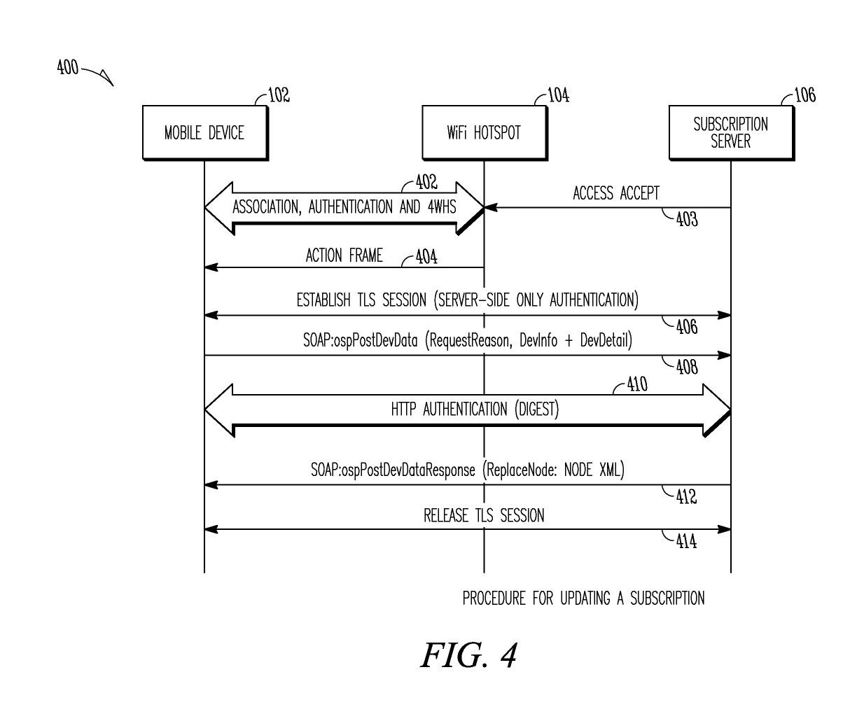

FIG. 4 illustrates messages exchanged as part of a procedure for updating a subscription in accordance with some embodiments. When a service provider determines that subscription needs to be updated, at the end of the EAP authentication sequence in operation 402, the service provider's AAA server may send an access-accept message 403 with a URL re-direct to the authenticator (i.e., the subscription server 106). The authenticator may instruct the Wi-Fi Hotspot 104 to transmit a vendor-specific action frame 404 to the mobile station 102 that indicates the need for updating its subscription.

In other embodiments, the subscription updating may be initiated by other techniques (i.e., other than by receipt of action frame 404). For example, limiting connectivity may indicate to the mobile device 102 that the subscription may need updating.

In operation 404, the mobile device may initiate a TLS connection to the subscription server 106. Server-side authentication may be performed when the mobile device 102 has username and password credentials. The mobile device 102 may verify that the certificate of the subscription server 106 has not been revoked using an Online Certificate Status Protocol (OCSP) within the TLS connection. If the certificate has been revoked, the mobile device 102 may be configured to abort the subscription update process. If the mobile device 102 is unable to initiate a TLS connection to the subscription server 106, the mobile device 102 may abort the subscription update process. In some embodiments, the mobile device 102 may be configured to refrain from updating the subscription using a (non-secure) HTTP and may be configured to use only secure HTTP (i.e., HTTPS) for subscription updating, although the scope of the embodiments is not limited in this respect

In operation 408, the mobile device 102 may be configured to transmit an ospPostDevData message in accordance with a SOAP technique to the subscription server 106. The message may be configured to include device information and device detail, such as OMA-DM protocol DevInfo and DevDetail. The value for the request reason field may be set to subscription update.

In operation 410, the subscription server 106 may request HTTP authentication using the digest method. The digest method may be performed in accordance with the procedures in RFC 5216. The mobile device 102 may provide a username and password digest to the server. If HTTP authentication is not successful, subscription updating may not be possible and the mobile device 102 may be configured to abort the process and may inform the user accordingly.

In operation 412, the subscription server 106 may transmit the ospPostDevDataResponse in accordance with a SOAP technique to the mobile device 102. The response may include XML data for one or more interior nodes of the subscription MO 200 (FIG. 2A). The mobile device 102 may be configured to replace one or more interior nodes of the subscription MO with updated credentials received in the message. The ospStatus in the ospPostDevDataResponse may be set to “update complete” to indicate the subscription update process has been completed.

In operation 414, the mobile device may release the TLS session that was established in operation 404 and may dissociate with the Wi-Fi network. The mobile device 102 may then re-associate using the credentials that were updated during the subscription update process.

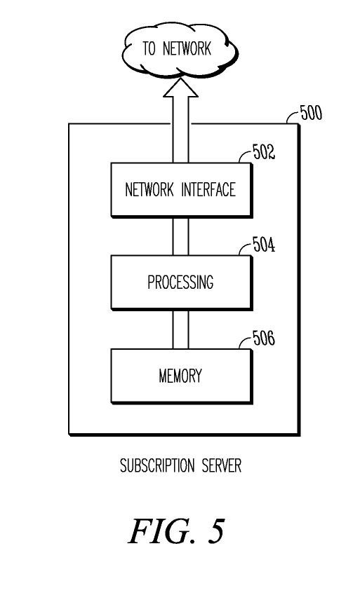

FIG. 5 is a functional block diagram of a subscription server in accordance with some embodiments. Subscription server 500 may be suitable for use as subscription server 106, although other configurations may also be suitable. Subscription server 500 includes a network interface 502 for communicating over one or more networks including the Internet, processing circuitry 504 comprising one or more processors for performing the operations described herein, and storage elements such as memory 506. In accordance with embodiments, subscription server 500 may be configured to generate subscription MOs, such as subscription MO 200 (FIG. 2A), for provisioning mobile devices as described herein.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the mobile device 102 and the subscription server 106 may include one or more processors and may be configured with instructions stored on a computer-readable storage device. In some embodiments, a non-transitory computer-readable storage medium that stores instructions that include the subscription MO 200 for execution by one or more processors to perform operations for a mobile device to select and subscribe to a Wi-Fi Hotspot 2.0 of a Wi-Fi network in accordance with subscription information of the subscription MO 200.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A subscription server configured to generate and store a subscription management object (MO), the subscription MO comprising a plurality of nodes including a subscription node that defines a subscription that has been provisioned for service by a service provider, the subscription node including at least:
a home operator node that specifies home-operation information for an associated subscription; and
a credentials node that includes credentials for the associated subscription.

2. The subscription server of claim 1 wherein the subscription MO is a subscription-provisioning MO,
wherein the subscription server is further configured to provision a mobile device with the subscription MO, and
wherein when provisioned with the subscription MO, the mobile device is configured to create an instance of the subscription MO within the mobile device for use in selecting and subscribing to a wireless hotspot of a wireless network in accordance with subscription information of the subscription MO.

3. The subscription server of claim 2 wherein the subscription node serves as a placeholder for subscription instance information for one or more subscriptions, and
wherein the subscription node includes a subscription server URI leaf node that specifies a uniform resource identifier (URI) of the subscription server.

4. The subscription server of claim 1 wherein the home operator node includes:
a network ID node for network identity related information, the network ID node including one or more leaf nodes that each specify a wireless network name of a wireless network to which the subscription is applicable.

5. The subscription server of claim 4 wherein the home operator node includes:
a leaf node that specifies the friendly name of a home operator for the associated subscription;
a leaf node that specifies a fully qualified domain name (FQDN) of the home operator in a predetermined format;
a realm leaf node that specifies a realm of the home operator in a predetermined format;
a leaf node comprising the organizational identifiers identifying the home service provider in a predetermined formation; and
an update node that includes an update interval parameter and a URI of the home service provider for receiving updates.

6. The subscription server of claim 5 wherein the home operator node optionally includes:
a roaming consortium organizational identifiers (OI) node that includes organizational identifiers that identify any roaming consortiums of which the service provider is a member.

7. The subscription server of claim 1 wherein the subscription MO optionally includes:
a policy node that identifies operator policy for the associated subscription; and
a subscription management node that identifies subscription management parameters for the associated subscription.

8. The subscription server of claim 7 wherein the policy node includes:
a roaming partner list node that identifies the roaming partner priority list;
an operator blacklist node that includes an operator blacklist that lists operator friendly names which are not preferred by the home operator; and
a policy server node that identifies a policy server.

9. The subscription server of claim 8 wherein the policy server node includes:
a leaf node that specifies the URI of the policy server in a predetermined format; and
a leaf node that specifies an update interval for policy updates.

10. The subscription server of claim 1 wherein the subscription management node includes:
a creation date leaf node that specifies a date and time when the subscription was created;
an expiration date leaf node that specifies an expiration date and time for the subscription; and
an optional usage-limit node that specifies accumulated usage statistical limits for this subscription.

11. The subscription server of claim 1 wherein the credentials node includes at least one of:
a username-password interior node that serves as a container for username and password values of the credentials and includes a username leaf node for a username, and a password leaf node for a password; and
a digital certificate interior node that serves as a container for certificate-based credentials and includes a certificate-type leaf node that specifics a certificate type, a certificate-issuer leaf node that specifies a certificate issuer and a serial-number leaf node that specifies a serial number of the certificate.

12. The subscription server of claim 1 wherein the subscription MO includes an optional vendor extension (Ext) node to store vendor specific information about the subscription MO.

13. The subscription server of claim 1 wherein at least some of the nodes of the subscription MO are encoded in accordance with a multi-byte character encoding format.

14. A mobile device comprising a memory to store a subscription management objection (MO) and one or more processors configured to perform operations for hotspot connectivity in accordance with subscription information of the subscription MO,
wherein the subscription MO comprises a plurality of nodes including a subscription node that defines a subscription that has been provisioned for service by a service provider, the subscription node including at least:
a home operator node that specifies home-operation information for an associated subscription; and
a credentials node that includes credentials for the associated subscription.

15. The mobile device of claim 14 wherein the subscription MO optionally includes:
a policy node that identifies operator policy for the associated subscription; and
a subscription management node that identifies subscription management parameters for the associated subscription,
wherein the policy node includes:
a roaming partner list node that identifies the roaming partner priority list;
an operator blacklist node that includes an operator blacklist that lists operator friendly names which are not preferred by the home operator; and
a policy server node that identifies a policy server, and
wherein the subscription management node includes:
a creation date leaf node that specifies a date and time when the subscription was created;
an expiration date leaf node that specifies an expiration date and time for the subscription; and
an optional usage-limit node that specifies accumulated usage statistical limits for this subscription.

16. The mobile device of claim 14, wherein the mobile device is configured to:
associate with a wireless network through a wireless Hotspot using an Extensible Authentication Protocol (EAP) technique, wherein as part of the associating, a RADIUS ACCESS-ACCEPT message is received by the wireless hotspot from an AAA server to allow the mobile device access to the wireless network and establish a wireless connection with the mobile device;
perform an initial Simple Object Access Protocol (SOAP) exchange with a subscription server over the established wireless connection to request provisioning of credentials or request subscription establishment, the initial SOAP exchange including the mobile device authenticating the subscription server;
exchanging information with the subscription server to establish a subscription with a service provider for wireless network access, to provision credentials for the subscription, and to create an instance of the subscription MO for the provisioned credentials; and
perform a final SOAP exchange with the subscription server over the wireless network to receive the subscription MO.

17. The mobile device of claim 16 wherein when provisioned with the subscription MO, the mobile device is configured to create an instance of the subscription MO within the mobile device for use in selecting and subscribing to a wireless hotspot of a wireless network in accordance with the subscription information of the subscription MO.

18. The mobile device of claim 17 wherein the subscription node serves as a placeholder for subscription instance information for one or more subscriptions,
wherein the subscription node includes a subscription server URI leaf node that specifies a uniform resource identifier (URI) of the subscription server,
wherein the home operator node includes a network ID node for network identity related information, the network ID node including one or more leaf nodes that each specify a wireless network name of a wireless network to which the subscription is applicable, and
wherein the policy server node includes:
a leaf node that specifies the URI of the policy server in a predetermined format; and
a leaf node that specifies an update interval for policy updates.

19. The mobile device of claim 17 wherein the credentials node includes at least one of:
a username-password interior node that serves as a container for username and password values of the credentials and includes a username leaf node for a username, and a password leaf node for a password; and
a digital certificate interior node that serves as a container for certificate-based credentials and includes a certificate-type leaf node that specifics a certificate type, a certificate-issuer leaf node that specifies a certificate issuer and a serial-number leaf node that specifies a serial number of the certificate.

20. A non-transitory computer-readable storage medium that stores instructions for execution by one or more processors for selecting and subscribing to a hotspot of a wireless network in accordance with subscription information of a subscription management objection (MO),
wherein the subscription MO comprises a plurality of nodes including a subscription node that defines a subscription that has been provisioned for service by a wireless network service provider, the subscription node including at least:
a home operator node that specifies home-operation information for an associated subscription; and
a credentials node that includes credentials for the associated subscription, and
optionally including:
a policy node that identifies operator policy for the associated subscription; and
a subscription management node that identifies subscription management parameters for the associated subscription.

21. The non-transitory computer-readable storage medium of claim 20 wherein the subscription node serves as a placeholder for subscription instance information for one or more subscriptions,
wherein the subscription node includes a subscription server URI leaf node that specifies a uniform resource identifier (URI) of the subscription server,
wherein the home operator node includes a network ID node for network identity related information, the network ID node including one or more leaf nodes that each specify a wireless network name of the wireless network to which the subscription is applicable, and
wherein the policy server node includes:
a leaf node that specifies the URI of the policy server in a predetermined format; and
a leaf node that specifies an update interval for policy updates.

22. The non-transitory computer-readable storage medium of claim 21 wherein the credentials node includes at least one of:
a username-password interior node that serves as a container for username and password values of the credentials and includes a username leaf node for a username, and a password leaf node for a password; and
a digital certificate interior node that serves as a container for certificate-based credentials and includes a certificate-type leaf node that specifics a certificate type, a certificate-issuer leaf node that specifies a certificate issuer and a serial-number leaf node that specifies a serial number of the certificate.
